(19) United States
(12) Patent Application Publication
(10) Pub. No.: US 2017/0175871 A1
(43) Pub. Date: Jun. 22, 2017

(54) RESIN GEAR

(71) Applicant: NIPPON GASKET Co., Ltd., Toyota-shi (JP)

(72) Inventor: Shigeo SHINOZAKI, Toyota-shi (JP)

(21) Appl. No.: 15/378,485

(22) Filed: Dec. 14, 2016

(30) Foreign Application Priority Data
Dec. 16, 2015 (JP) 2015-244905

(51) Int. Cl. F16H 55/08; F16H 55/06

(52) U.S. Cl. CPC F16H 55/08; F16H 55/06; F16H 2055/0893

(57) ABSTRACT

A resin gear 12 includes tooth surfaces 13a and 13b formed front and rear with respect to a rotating direction and an addendum 13c formed between these tooth surfaces and also includes a plurality of helical teeth 13 provided with inclination at a predetermined twist angle with respect to an axial direction.

On a part of a contact portion on the tooth surface with a tooth surface of the other gear, a relief portion 15 so as not to touch the tooth surface of the other gear is formed.

Damage on the tooth surface caused by stress concentration can be prevented as much as possible.

### BACKGROUND OF THE INVENTION

### Field of the Invention

The present invention relates to a resin gear and relates to a resin gear made of resin, including helical teeth provided at a predetermined twist angle with respect to an axial direction.

### Description of the Related Art

Conventionally, as a gear used in a gear device, a resin gear made of resin including a helical tooth including tooth surfaces formed front and rear with respect to a rotating direction and addendums formed between these teeth and also provided at a predetermined twist angle with respect to the axial direction is known (Japanese Patent Laid-Open No. 2012-52650).

In the aforementioned resin gear including the helical teeth, when the other gear to be meshed is rotated, a contact portion on the aforementioned helical tooth with a tooth surface of the other gear is moved from one end to the other end along the tooth surface so that the resin gear is rotated by a driving force transmitted through the contact portion.

Here, in the case of the helical gear made of resin illustrated in Japanese Patent Laid-Open No. 2012-52650, when a stress acting on the helical tooth increases, the helical tooth made of resin with a low modulus of elasticity is deformed, and repeated action of such stress causes damage such as pitching in the tooth surface.

In view of the problem as above, the present invention has an object to provide a resin gear capable of preventing damage on the tooth surface as much as possible.

### SUMMARY OF THE INVENTION

That is, a resin gear according to the present invention is a resin gear made of resin, the resin gear including a plurality of helical teeth including tooth surfaces formed front and rear with respect to a rotating direction and addendums formed between these tooth surfaces and also provided at a predetermined twist angle with respect to an axial direction,

a contact portion on the tooth surface of the helical tooth with a tooth surface of another meshed gear being moved from one end to the other end of the tooth surface, when the other gear is rotated,

characterized in that a relief portion so as not to touch the tooth surface of the other gear is formed on a part of the contact portion on the tooth surface with the tooth surface of the other gear.

According to the aforementioned invention, even if the helical tooth made of resin is deformed, a stress can be made to uniformly act on the entire tooth surface by the relief portion, whereby damage such as pitching as described above can be prevented.

### BRIEF DESCRIPTION OF THE DRAWINGS

FIG. 1 is a sectional view illustrating an embodiment of the present invention;

FIG. 2 is a front view of a driven gear in FIG. 1;

FIG. 3 is a plan view of helical teeth;

FIG. 4 is a perspective view of a helical tooth;

FIG. 5 is a view illustrating an experiment result; and

FIG. 6 is a plan view of helical teeth according to another embodiment.

### DETAILED DESCRIPTION OF THE PREFERRED EMBODIMENTS

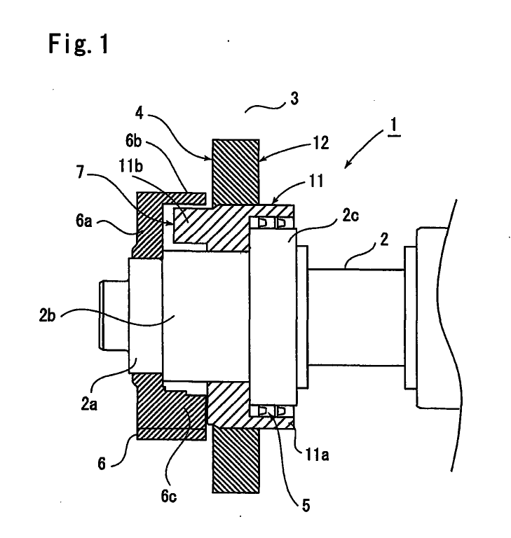

The present invention will be described below on the basis of illustrated embodiment, in which FIG. 1 illustrates a gear device 1 constituting a part of a balance shaft device, and this gear device 1 is provided below a cylinder block, not shown. In FIG. 1, a left side in the illustration is assumed to be front or a distal end side, while a right side in the illustration is assumed to be a rear or a rear end side.

The gear device 1 includes a rotating shaft 2 pivotally supported by a housing, not shown, a driven gear 4 fitted with the rotating shaft 2, capable of relative rotation, and meshed with a driving gear 3, a friction damper 5 provided between the rotating shaft 2 and the driven gear 4, a cover 6 fixed to a distal end portion of the rotating shaft 2, and a rotation transmission mechanism 7 provided between the driven gear 4 and the cover 6.

The driving gear 3 is a helical gear made of metal and rotated by driving of an engine and operates the gear device 1 by transmitting the driving force to the driven gear 4.

The rotating shaft 2 is made of metal and is pivotally supported rotatably by the housing through a bearing, not shown.

The rotating shaft 2 includes a small-diameter portion 2a formed on the distal end portion and with which the cover 6 is fitted, a large-diameter portion 2b formed on the rear of the small-diameter portion 2a and with which the driven gear 4 is rotatably fitted, and a flange portion 2c formed in the rear of the large-diameter portion 2b.

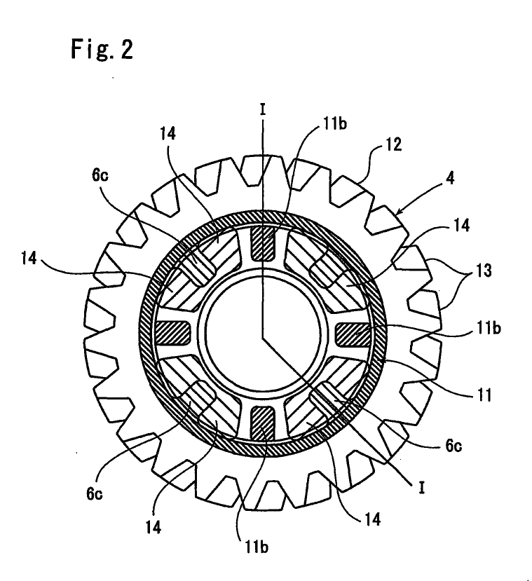

As illustrated in FIG. 2, the driven gear 4 is constituted by a ring-shaped insert portion 11 and a ring-shaped resin gear 12 fitted on an outer periphery of this insert portion 11, and the insert portion 11 and the resin gear 12 are fixed by a projection, not shown, formed on the outer periphery of the insert portion 11 so as not to make relative rotation.

The insert portion 11 is made of metal, and its inner periphery is formed having substantially the same shape as that of the large-diameter portion 2b of the rotating shaft 2 and thus, the driven gear 4 moves in an axial direction along the large-diameter portion 2b of the rotating shaft 2 and is capable of relative rotation in a circumferential direction.

On a rear side of the insert portion 11, a cylindrical ring-shaped projection 11a extending in the axial direction is formed, and on the front of the insert portion 11, four first engagement portions 11b constituting the rotation transmission mechanism 7 are protruded toward the front as will be described later in detail.

Then, the friction damper 5 is provided between an inner peripheral surface of the ring-shaped projection 11a of the insert portion 11 in the driven gear 4 and an outer peripheral surface of the flange portion 2c of the rotating shaft 2.

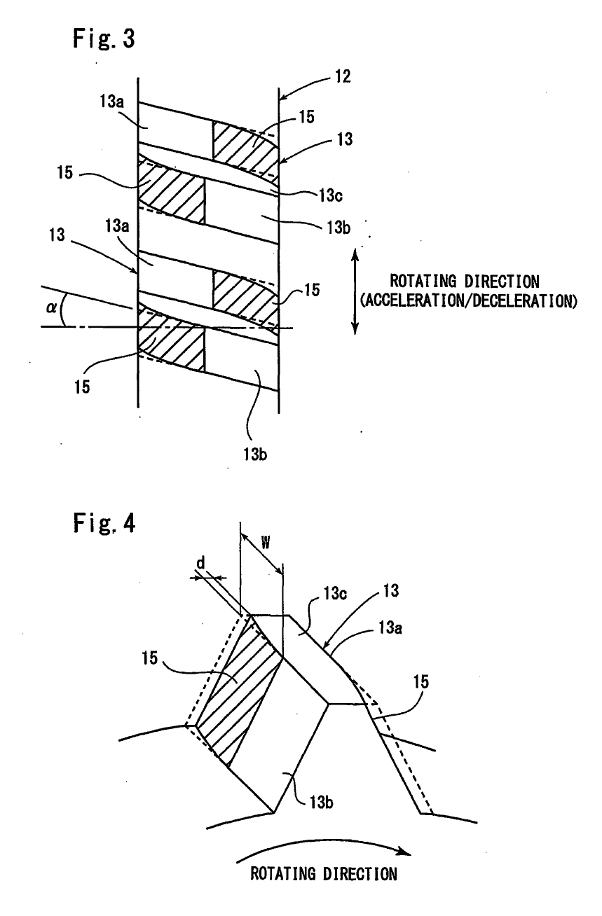

The resin gear 12 is a helical gear, helical teeth 13 are formed on the outer periphery thereof at equal intervals as illustrated in FIGS. 3 and 4, and helical teeth each having the substantially same shape to be meshed with the helical teeth 13 are formed on the driving gear 3.

A manufacturing method of the driven gear 4 including the resin gear 12 will be described below, but since that is known in Japanese Patent Laid-Open No. 2012-52650, detailed description will be omitted.

First, a sheet-shaped resin is manufactured by sheet forming. Specifically, a phenol resin powder which is a thermosetting resin, an aramid fiber as a reinforcing fiber, and aramid pulp are dispersed in water, respectively, and a sheet-shaped resin is manufactured by sheet-forming of this, and this is input into a pressurizing press machine for dewatering.

Subsequently, the sheet-shaped resin obtained as above is cut into a gear shape, and a circular hole in which the insert portion 11 is to be fitted is drilled. After that, each of the sheet-shaped resin having the gear shape is laminated by having a position of the tooth portion matched with each other and compressed in a laminating direction while being heated at a predetermined temperature so that a tablet having a spur gear shape is obtained.

Then, this tablet having the spur gear shape is heated/pressurized and the formed tablet which was heated and softened is press-fitted into a molding space formed having a helical gear shape so that the resin gear 12 with the helical teeth 13 is formed is obtained.

At that time, by press-fitting the insert portion 11 into the tablet which was heated and softened, the projection formed on the outer periphery of the insert portion 11 pushes away the softened resin and enters so that the driven gear 4 in which the resin gear 12 is attached to the insert portion 11 can be obtained.

The cover 6 is a cylindrical member with a bottom fixed to the small-diameter portion 2a of the rotating shaft 2 and is constituted by a disk-shaped bottom portion 6a through which the small-diameter portion 2a is penetrated at a center thereof and a cylindrical portion 6b protruding from the bottom portion 6a in the axial direction and having a cylindrical shape.

The bottom portion 6a is fixed to the rotating shaft 2, whereby the cover 6 and the rotating shaft 2 are integrally rotated. An inner diameter of the cylindrical portion 6b is larger than a diameter of the insert portion 11 of the driven gear 4, and its axial dimension is set longer than the axial dimension of the first engagement portion 11b of the insert portion 11.

As illustrated in FIG. 2, the rotation transmission mechanism 7 is constituted by the four first engagement portions 11b formed in front of the insert portion 11 in the driven gear 4, four second engagement portions 6c formed on an inner peripheral surface of the cylindrical portion 6b of the cover 6, and a stopper rubber 14 attached to the second engagement portion 6c.

The stopper rubber 14 has a substantially fan shape in which a recess portion for accommodating the second engagement portion 6c formed at a center part thereof, and the first engagement portion 11b is located between the stopper rubber 14 and the stopper rubber 14 adjacent to each other.

Moreover, a gap formed by the stopper rubber 14 and the stopper rubber 14 adjacent to each other is set larger than a width of the first engagement portion 11b, and thus, as illustrated in FIG. 3, in a state where the first engagement portion 11b is not in contact with the stopper rubber 14, the driven gear 4 is relatively rotated with respect to the rotating shaft 2 so that the rotating shaft 2 is not rotated.

After that, when the driven gear 4 is relatively rotated with respect to the rotating shaft 2, the first engagement portion 11b comes into contact with the adjacent stopper rubber 14 and presses it and thus, the driven gear 4 is rotated integrally with the rotating shaft 2.

Furthermore, if a rotating speed of the driven gear 4 lowers, the rotating shaft 2 is to maintain the rotating speed by inertia and thus, the driven gear 4 is rotated in an opposite direction with respect to the rotating shaft 2, whereby the first engagement portion 11b is separated from the stopper rubber 14 on a front side in the rotating direction and comes into contact with the stopper rubber 14 on a rear side in the rotating direction.

As a result, the rotating shaft 2 is decelerated to the rotating speed of the driven gear 4, and as described above, the gear device 1 operates as a balance shaft device.

As in the gear device 1 of this embodiment, the driven gear 4 is rotated by the driving force from the driving gear 3, but the driving force of the driving gear 3 at that time is transmitted from the helical teeth of the driving gear 3 to the helical teeth 13 of the driven gear 4.

FIG. 3 illustrates a plan view of the helical teeth 13 constituting the resin gear 12 of the driven gear 4, and FIG. 4 illustrates a perspective view of the helical tooth 13. In FIG. 2, the resin gear 12 is rotated from a lower side to an upper side in the figure, and in FIG. 3, the resin gear 12 is rotated clockwise.

Each of the helical teeth 13 is formed at an equal interval and is constituted by a front tooth surface 13a formed on front with respect to the rotating direction, a rear tooth surface 13b formed on a rear in the rotating direction, and an addendum 13c formed between the front tooth surface 13a and the rear tooth surface 13b, and the helical tooth 13 is provided with inclination only at a twist angle a with respect to the axial direction.

When the driving gear 3 and the driven gear 4 including the helical teeth as above are meshed with each other and rotated, the front tooth surface of the driving gear 3 comes into contact into the rear tooth surface 13b of the of the helical tooth 13 in the driven gear 4, and while these contact portions move from one end to the other end in the axial direction in the tooth surface, the driving force of the driving gear 3 is transmitted to the driven gear 4.

Here, if the driving gear 3 drives the driven gear 4 with a large driving force or the device is used as the balance shaft device, when the first engagement portion 11b of the rotation transmission mechanism 7 collides against the stopper rubber 14 located front and rear in the rotating direction, a large stress acts on the helical teeth 13 of the resin gear 12 from the driving gear 3.

Since the resin gear 12 constituting the driven gear 4 as in this embodiment is made of resin with a low modulus of elasticity, the action of the large stress as described above deforms the helical teeth 13, and it was confirmed that, particularly when the resin gear 12 is used as the driven gear 4, the helical teeth 13 are to be deformed in a direction where the twist angle decreases.

Specifically, it was confirmed that, when the driven gear 4 starts rotation by the upper driving gear 3 or when the rotating speed increases, the acting stress concentrates on a vicinity of an end portion in the rear tooth surface 13b in an upstream side in the rotating direction, while when the driven gear 4 is decelerated by the upper driving gear 3, the acting stress concentrates on the vicinity of an end portion in the front tooth surface 13a on a downstream side in the rotating direction.

If the stress concentrates on a part of the tooth surface of the helical tooth 13 as described above, it was confirmed that damage such as pitching can occur on the portion where the stress concentrates as indicated in the following experiment.

In order to handle such a problem, in the resin gear 12 constituting the driven gear 4 of this embodiment, a relief portion 15 is formed in the front tooth surface 13a and the rear tooth surface 13b of each of the helical teeth 13 so as to prevent damage on the tooth surface caused by the stress concentration as much as possible.

Specifically, the relief portion 15 is formed in the vicinity of the end portion of the front tooth surface 13a on the downstream side in the rotating direction and the vicinity of the end portion in the rear tooth surface 13b on the upstream side in the rotating direction where the stress concentrates.

More specifically, the relief portion 15 is formed so that its relief amount gradually increases from a substantially center part of the front tooth surface 13a to the end portion on the downstream side in the rotating direction and from the substantially center part of the rear tooth surface 13b to the end portion on the upstream side in the rotating direction, respectively.

Here, a width W of the relief portion 15 is preferably set within a range of 30 to 50% of each of the front tooth surface 13a and the rear tooth surface 13b, and a relief amount d in the tooth-surface end portion in the relief portion 15 is preferably set within a range of 1 to 3% of a thickness of the helical tooth 13.

By providing the relief portion 15, when the stress acts on the rear tooth surface 13b of the helical tooth 13, though the helical tooth 13 is deformed, the stress does not concentrate any more on the vicinity of the end portion of the front tooth surface 13a on the downstream side in the rotating direction and on the vicinity of the end portion in the rear tooth surface 13b on the upstream side in the rotating direction by means of the relief portion 15 but the stress acts on the entire tooth surface in a distributed manner and thus, the pitching as described above can be prevented.

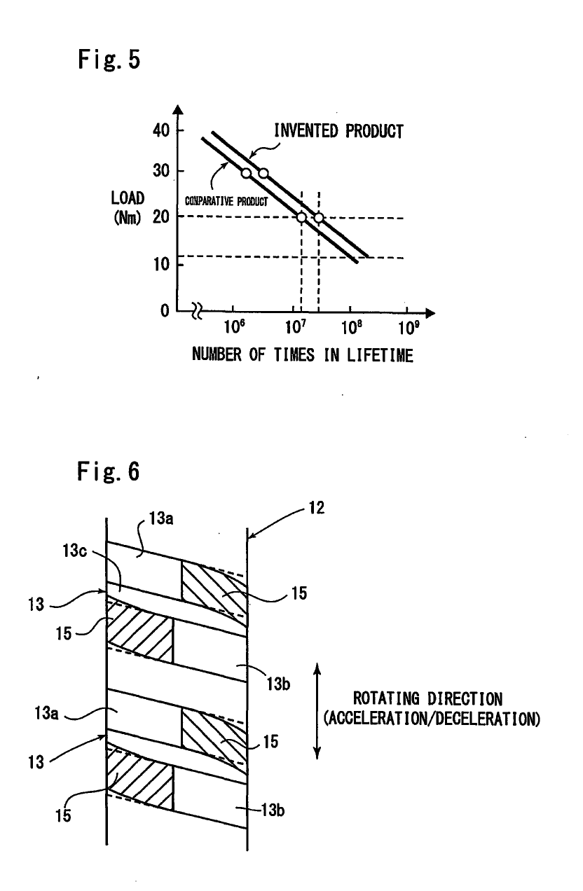

FIG. 5 shows an experiment result conducted for the resin gear 12 (invented product) including the helical tooth 13 on which the relief portion 15 is formed and the resin gear 12 (comparative product) including the helical tooth 13 on which the relief portion 15 is not formed.

As the resin gear 12 used in the experiment, a helical gear having a thickness in the axial direction of 10 mm, a diameter of 90 mm, and 20 teeth is used, in which each of the helical teeth 13 is inclined at a twist angle of 30° with respect to the axial direction, respectively.

Moreover, the width W of the relief portion 15 in the invented product was provided in the vicinity of the end portion of the front tooth surface 13a on the downstream side in the rotating direction and at a position of the rear tooth surface 13b on the upstream side in the rotating direction within a range of 50%, and the relief amount d in the tooth-surface end portion was set to 2% of the thickness of the helical tooth 13.

The resin gear 12 according to the invented product and the comparative product was used as the driven gear 4 as in the embodiment, and a helical gear made of metal was used as the driving gear 3 for transmitting the driving force.

Then, the driving gear 3 was rotated at a predetermined rotation number with a predetermined driving force (load), and presence of damage on the tooth surface was checked at every predetermined rotation number while the number of contact times of the tooth portion of the driving gear 3 with the rear tooth surface 13b of the helical tooth 13 was counted.

In FIG. 5, a vertical axis indicates the driving force (load), and a lateral axis indicates the number of times in lifetime, that is, the number of rotations by which the stress acted on the rear tooth surface 13b until damage occurs, and as is obvious from the experiment, the number of times in lifetime was larger by approximately 60% when the invented product was driven with the same driving force, and it was confirmed that the damage by the stress concentration could be effectively prevented.

Moreover, in the aforementioned embodiment, the case where the resin gear 12 is used for the gear device 1 of the balance shaft device is described, but it can be also used for the gear device 1 having other constitutions including the resin gear 12.

Particularly, in the aforementioned embodiment, the resin gear 12 is used as the driven gear 4, but the resin gear 12 can be also used as the driving gear 3, and in that case, too, the stress acts on the helical teeth 13.

That is, when the resin gear 12 is used as the driving gear 3, as illustrated in FIG. 6, the front tooth surface 13a of the helical tooth 13 comes into contact with the helical tooth 13 of the driven gear 4 and transmits the driving force and thus, the stress concentrates on a position in the front tooth surface 13a on the downstream side in the rotating direction, while the stress concentrates on a position in the rear tooth surface 13b on the upstream side in the rotating direction in case of deceleration.

Thus, similarly to the aforementioned embodiment, even in the case where the resin gear 12 is used as the driving gear 3, by forming the relief portion 15 on the downstream side in the rotating direction in the front tooth surface 13a and on the upstream side in the rotating direction in the rear tooth surface 13b, damage on the tooth surface caused by deformation of the helical tooth 13 can be prevented.

The width W and the relief amount d of the relief portion 15 at that time are set as in the aforementioned embodiment.

The aforementioned embodiment describes the case where the resin gear 12 is used in the balance shaft device and since the resin gear 12 in the balance shaft device repeats acceleration/deceleration as described above, the relief portion 15 is provided both on the front tooth surface 13a and on the rear tooth surface 13b.

On the other hand, in the case where the resin gear 12 is used in a device not requiring acceleration/deceleration, for example, the relief portion 15 on either one of the front tooth surface 13a and the rear tooth surface 13b can be omitted.

That is, when the resin gear 12 is used as the driven gear 4 as in the first embodiment, the relief portion 15 on the front tooth surface 13a can be omitted, while in the case of use as the driving gear 3, the relief portion 15 on the rear tooth surface 13b can be omitted.

### REFERENCE SIGNS LIST

1 gear device

3 driving gear

4 driven gear

11 insert portion

12 resin gear

13 helical tooth

13a front tooth surface

13b rear tooth surface

15 relief portion

1. A resin gear made of resin, the resin gear comprising:
a plurality of helical teeth including tooth surfaces formed front and rear with respect to a rotating direction and addendums formed between these tooth surfaces and also provided at a predetermined twist angle with respect to an axial direction,
a contact portion on the tooth surface of the helical tooth with a tooth surface of another meshed gear being moved from one end to the other end of the tooth surface, when the other gear is rotated,
characterized in that a relief portion so as not to touch the tooth surface of the other gear is formed on a part of the contact portion on the tooth surface with the tooth surface of the other gear.

2. The resin gear according to claim 1, characterized in that
when the resin gear is a driven gear, the relief portion is formed on a rear tooth surface located on a rear in the rotating direction of the resin gear and also formed so that a relief amount gradually increases from a substantially center part in the rear tooth surface to an end portion on an upstream side in the rotating direction.

3. The resin gear according to claim 1, characterized in that
when the resin gear is a driving gear, the relief portion is formed on a front tooth surface located on a front in the rotating direction of the resin gear and also formed so that a relief amount gradually increases from a substantially center part in the front tooth surface to an end portion on a downstream side in the rotating direction.

4. The resin gear according to claim 2, characterized in that
a width of the relief portion is provided within a range of 30 to 50% of the tooth surface, and the relief amount in the tooth surface end portion of the relief portion is provided within a range of 1 to 3% of a thickness of the helical tooth.
